(19) United States
(12) Patent Application Publication
(10) Pub. No.: US 2026/0081741 A1
(43) Pub. Date: Mar. 19, 2026

(54) REQUEST PROCEDURE FOR MLD INFORMATION SHARING

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US); Bilal Sadiq, Plano, TX (US)

(21) Appl. No.: 19/329,422

(22) Filed: Sep. 15, 2025

Related U.S. Application Data
(60) Provisional application No. 63/696,194, filed on Sep. 18, 2024.
(60) Provisional application No. 63/696,711, filed on Sep. 19, 2024.

(51) Int. Cl. H04L 5/00; H04W 28/02; H04W 60/04

(52) U.S. Cl. CPC H04L 5/0053; H04W 28/0268; H04W 60/04

(57) ABSTRACT

A station (STA) includes a processor configured to perform negotiation for statistics information sharing with an access point (AP). The STA also includes a transceiver operatively coupled to the processor. The transceiver is configured to, as part of the negotiation, transmit to the AP, a request frame indicating a request to receive statistics reports from the AP. The transceiver is also configured to, as part of the negotiation, receive, from the AP, a response frame acknowledging the request and indicating one of (i) acceptance of the request, (ii) rejection of the request, or (iii), a suggestion of an alternative proposal to the request.

### CROSS-REFERENCE TO RELATED APPLICATION(S) AND CLAIM OF PRIORITY

This application claims priority under 35 U.S.C. § 119(e) to U.S. Provisional Patent Application No. 63/696,194 filed on Sep. 18, 2024, and U.S. Provisional Patent Application No. 63/696,711 filed on Sep. 19, 2024. The above-identified provisional patent applications are hereby incorporated by reference in their entirety.

### TECHNICAL FIELD

This disclosure relates generally to wireless networks. More specifically, this disclosure relates to request procedures for multi-link device (MLD) information sharing.

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for MLD information sharing requests.

In one embodiment, a station (STA) is provided. The STA includes a processor configured to perform negotiation for statistics information sharing with an access point (AP). The STA also includes a transceiver operatively coupled to the processor. The transceiver is configured to, as part of the negotiation, transmit to the AP, a request frame indicating a request to receive statistics reports from the AP. The transceiver is also configured to, as part of the negotiation, receive, from the AP, a response frame acknowledging the request and indicating one of (i) acceptance of the request, (ii) rejection of the request, or (iii), a suggestion of an alternative proposal to the request.

In one embodiment, an AP is provided. The AP includes a processor configured to perform negotiation for statistics information sharing with a STA. The AP also includes a transceiver operatively coupled to the processor. The transceiver is configured to, as part of the negotiation, receive, from the STA, a request frame indicating a request to receive statistics reports from the AP. The transceiver is also configured to, as part of the negotiation, transmit, to the STA, a response frame acknowledging the request and indicating one of (i) acceptance of the request, (ii) rejection of the request, or (iii), a suggestion of an alternative proposal to the request.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example wireless network where infrastructure traffic and non-infrastructure traffic coexist according to embodiments of the present disclosure;

FIG. 4 illustrates an example of solicited mode (aperiodic mode) statistics report sharing according to embodiments of the present disclosure;

FIG. 5 illustrates another example of solicited mode (aperiodic mode) statistics report sharing according to embodiments of the present disclosure;

FIG. 6 illustrates an example of unsolicited mode statistics report sharing according to embodiments of the present disclosure;

FIG. 7 illustrates an example of periodic mode statistics report sharing according to embodiments of the present disclosure;

FIG. 8 illustrates an example SCS request frame format that includes a latency stat report element field according to embodiments of the present disclosure;

FIG. 9 illustrates an example latency stat report element format according to embodiments of the present disclosure;

FIG. 10 illustrates an example control field format according to embodiments of the present disclosure;

FIG. 11 illustrates another example control field format according to embodiments of the present disclosure;

FIG. 12 illustrates an example classifier type bitmap field format according to embodiments of the present disclosure;

FIG. 13 illustrates an example SCS ID list format according to embodiments of the present disclosure;

FIG. 14 illustrates an example address set list format according to embodiments of the present disclosure;

FIG. 15 illustrates an example method for MLD information sharing according to embodiments of the present disclosure; and

FIG. 16 illustrates an example method for MLD information sharing according to embodiments of the present disclosure.

### DETAILED DESCRIPTION

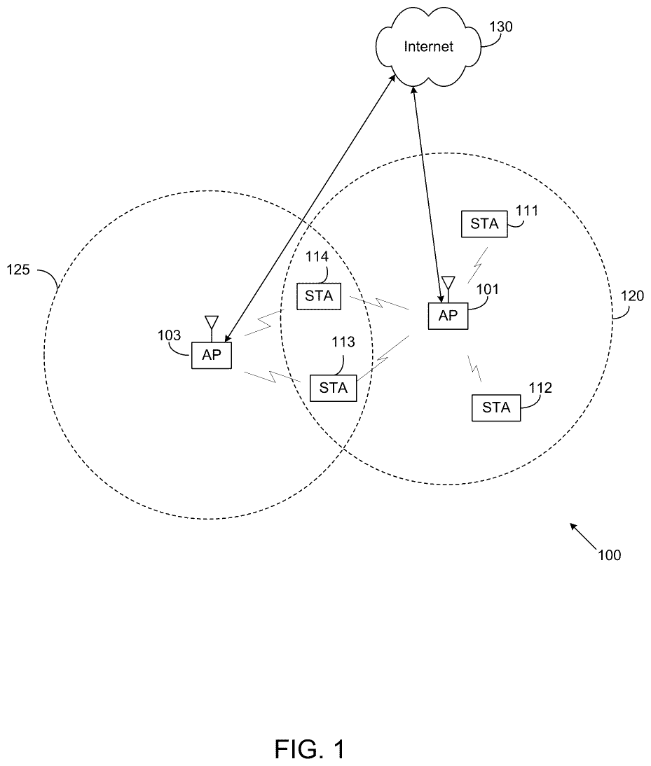

FIGS. 1 through 16, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP devices may be capable of communicating on different bands/links, which is referred to as multi-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

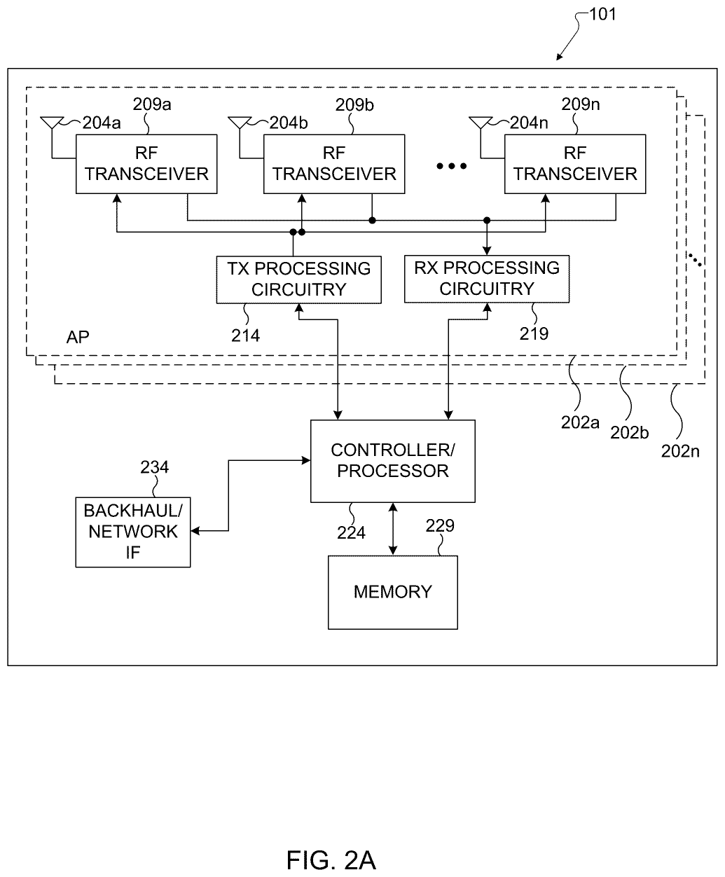

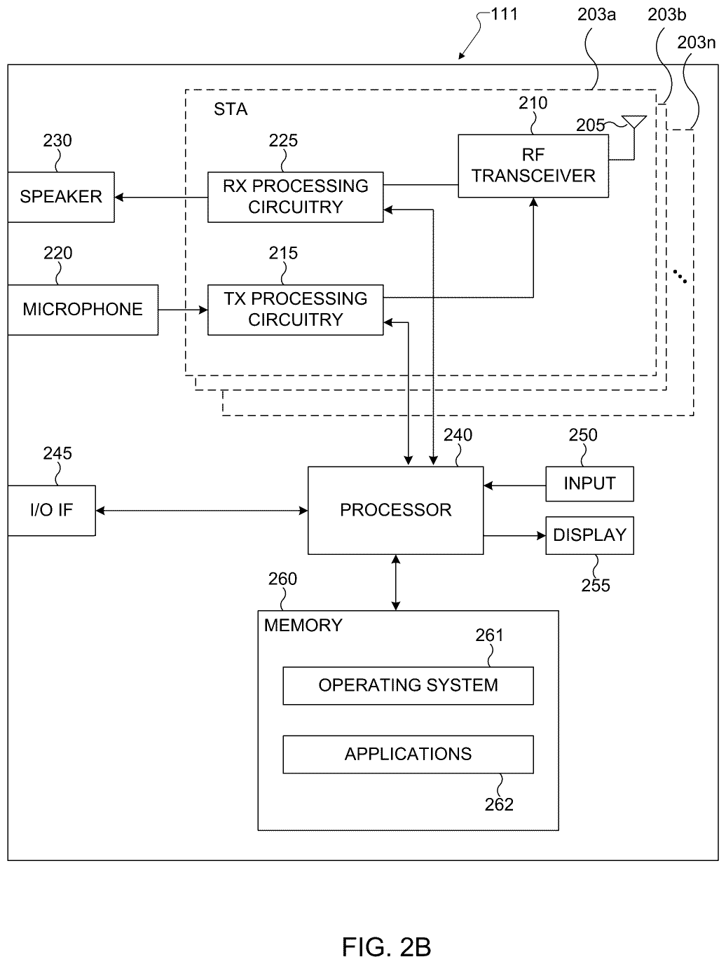

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHZ, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHZ, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHZ, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

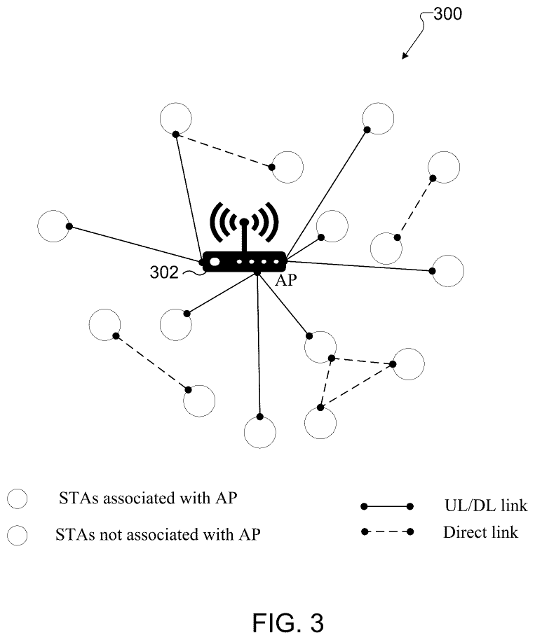

Better support for low-latency applications is desirable in next generation WLAN systems. It is not uncommon to observe numerous devices operating on the same wireless network. Many of such devices may be latency-tolerant but still contend with the devices with low-latency applications for the same time and frequency resources. In some cases, the AP as the network controller may not have enough control over the unregulated/unmanaged traffic that contends with the low-latency traffic within the infrastructure basic service set (BSS). Some of the unmanaged traffic that interferes with the AP's BSS's latency sensitive traffic may come from uplink (UL)/downlink (DL) or direct link communications within the infrastructure BSS that the AP manages. Other interference with the AP's BSS's latency sensitive traffic may be due to transmission in a neighboring infrastructure (overlapping) BSS (OBSS). Yet other interference with the AP's BSS's latency sensitive traffic may come from a neighboring independent BSS or P2P network as shown in FIG. 3.

FIG. 3 illustrates an example wireless network 300 where infrastructure traffic and non-infrastructure traffic coexist according to embodiments of the present disclosure. The embodiment of a wireless network of FIG. 3 is for illustration only. Different embodiments of a wireless network where infrastructure traffic and non-infrastructure traffic coexist could be used without departing from the scope of this disclosure.

In the example of FIG. 3, an AP 302 is associated with several STAs. The traffic between the AP and associated STAs is infrastructure traffic with respect to the network of AP 302. FIG. 3 also shows several STAs not associated with AP 302. Traffic generated by or transmitted to the STAs not associated with AP 302 is non-infrastructure traffic with respect to the network of AP 302.

Although FIG. 3 illustrates an example wireless network 300 where infrastructure traffic and non-infrastructure traffic coexist, various changes may be made to FIG. 3. For example, FIG. 3 could include additional APS, fewer or more STAs, etc. according to particular needs.

Wireless networks may support inclusion of a quality of service (QoS) characteristics element in stream classification service (SCS) request and response frames. For example, a non-AP STA may send, to an AP, an SCS request frame with a QoS Characteristics element that indicates the non-AP STA's traffic flow characteristics. In response, the AP may review the SCS request frame received from the non-AP STA and, upon acceptance, provision resources to the non-AP STA based on the traffic characteristics described in the QoS characteristics element included in the SCS request.

Once a non-AP STA has set up a QoS flow, for example through SCS setup, with its associated AP, constant exchange of performance metadata of QoS flow(s) between the AP and the STA ensures consistent QoS. This feedback loop allows the AP to adapt its service based on the STA's needs, network conditions, and location. Additionally, the STA can proactively utilize mechanisms to mitigate the impact of network degradation, thanks to this exchange of metadata. While wireless networking features (such as 802.11v diagnostics, WNM logs, and 802.11k statistics reports) provide a foundation, these features would benefit from updates and additions to cater to the demands of modern and emerging applications like augmented reality (AR)/virtual reality (VR) and internet of things (IoT), which are highly latency-sensitive and specialized. Analytics reporting between APs and STAs can help improve network performance.

In existing wireless networks, the latency statistics request procedure, as well as how to exchange capability information for sharing latency statistics is not well defined.

Various embodiments of the present disclosure provide mechanisms and frameworks for requesting a latency statistics report. Various embodiments of the present disclosure also provide mechanisms and frameworks for capability exchange for latency statistics information sharing.

In some embodiments, a first STA can request a second STA to share latency statistics information with the first STA. In embodiments such as these, the first STA can be either an AP or a non-AP STA, and the second STA can be an AP or a non-AP STA. For example, an AP can request an associated non-AP STA to share latency information with the AP.

In some embodiments, for the scenario where a first STA intends to request a second STA to share latency information, the first STA can send a SCS request frame to the second STA.

In some embodiments, a non-AP MLD can request its associated AP MLD to send latency statistics reports to the non-AP MLD.

In some embodiments, when a latency-sensitive application starts at a non-AP MLD, the non-AP MLD can request its associated AP MLD to send a latency statistics report to the non-AP MLD.

In some embodiments, an AP MLD can request one of its associated non-AP MLDs to send latency statistics reports to the AP MLD.

In some embodiments, when a latency-sensitive application starts at an AP MLD for an associated non-AP MLD, the AP MLD can request the associated non-AP MLD to send a latency statistics report to the AP MLD.

In some embodiments, an AP MLD can indicate its capability to share latency statistics reports with a non-AP MLD by including a corresponding capability field in at least one of a beacon, probe response, association response, or reassociation response frame transmitted by the AP MLD. In embodiments such as these, the capability field may be referred to as a statistics report sharing field. In some embodiments, if a statistics report sharing field is set to 1, this may indicate that the AP MLD supports sharing (latency) statistics reports with a non-AP MLD or with another AP MLD. Otherwise, if the statistics report sharing filed is set to 0, the AP MLD may not support sharing this report.

In some embodiments, a non-AP MLD can indicate its capability to share latency statistics reports with an AP MLD by including a corresponding capability field in at least one of a probe request, association request, or reassociation request frame transmitted by the non-AP MLD. In embodiments such as these, the capability field may be referred to as a statistics report sharing field. In some embodiments, if the statistics report sharing field is set to 1, this may indicate that the non-AP MLD supports sharing (latency) statistics reports with an AP MLD or with another non-AP MLD. Otherwise, if the statistics report sharing field is set to 0, the non-AP MLD may not support sharing this report.

In some embodiments, the MLD can include a statistics report sharing field in a high throughput (HT) capabilities element transmitted by the MLD.

In some embodiments, the MLD can include a statistics report sharing field in a very high throughput (VHT) capabilities element transmitted by the MLD.

In some embodiments, the MLD can include a statistics report sharing field in a high efficiency (HE) capabilities element transmitted by the MLD.

In some embodiments, the MLD can include a statistics report sharing field in an extremely high throughput (EHT) capabilities element transmitted by the MLD.

In some embodiments, the MLD can include a statistics report sharing field in an ultra high reliability (UHR) capabilities element transmitted by the MLD. In embodiments such as these, the UHR capabilities element may be defined for IEEE 802.11bn supported devices or Wi-Fi 8 supported devices.

In some embodiments, the MLD can include a statistics report sharing field in a Wi-Fi Alliance (WFA)-specific element or field transmitted by the MLD. In embodiments such as these, the WFA-specific element or field can be a vendor-specific element or field.

In some embodiments, if a first MLD supports sharing (latency) statistics reports with a second MLD, then the first MLD can set the value of a corresponding management information base (MIB) variable (e.g., dot11StatisticsReportSharing) to true. Otherwise, if the first MLD does not support sharing (latency) statistics reports with the second MLD, then the first MLD can set the value of the corresponding MIB variable to false.

In some embodiments, if a non-AP MLD intends to request its associated AP MLD to share the AP MLD's latency statistics report with the non-AP MLD, then the non-AP MLD can send a statistics report-sharing request to the AP MLD.

In some embodiments, if an AP MLD intends to request one of its associated non-AP MLDs to share the non-AP MLD's latency statistics report with the AP MLD, then the AP MLD can send a statistics report-sharing request to the non-AP MLD.

In some embodiments, a non-AP MLD may send a statistics report-sharing request to its associated AP MLD if the non-AP MLD has received a capabilities element (e.g., an HT/VHT/HE/EHT/UHR capabilities element) with the statistics report sharing field set to 1 from the AP MLD. Otherwise, in embodiments such as these, the non-AP MLD may not send the request.

In some embodiments, an AP MLD may send a statistics report-sharing request to one of its associated non-AP MLDs if the AP MLD has received a capabilities element (e.g., an HT/VHT/HE/EHT/UHR capabilities element) with the statistics report sharing field set to 1 from the non-AP MLD. Otherwise, in embodiments such as these, the AP MLD may not send the request.

In some embodiments, statistics report sharing may be performed according to a particular mode. In embodiments such as these, the particular mode may be one of a solicited mode (aperiodic mode), an unsolicited mode, and a periodic mode, as described in more detail below.

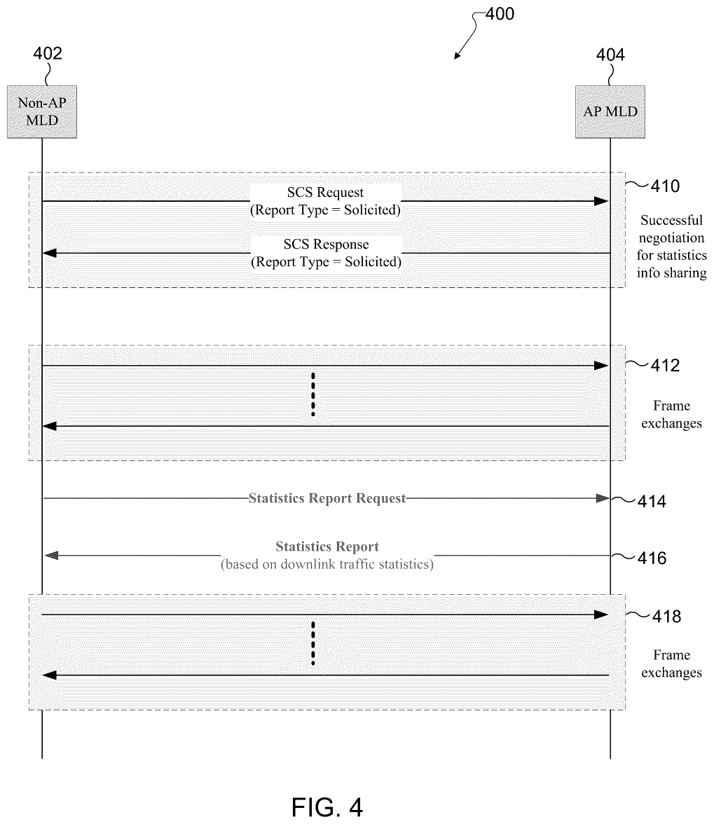

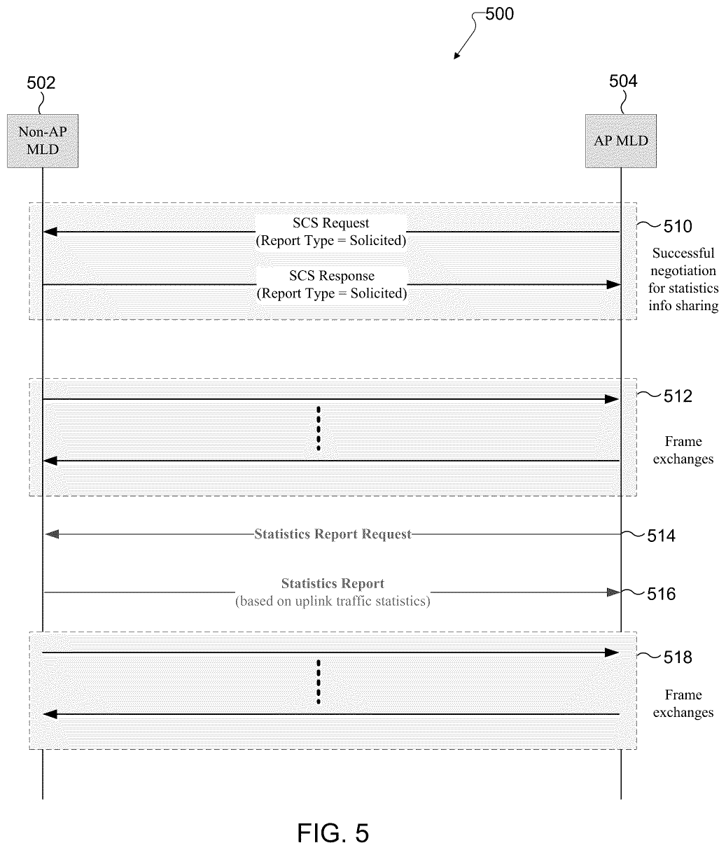

In the solicited mode (aperiodic mode) of statistics report sharing, a first MLD can share a latency statistics report with a second MLD when the first MLD receives a statistics report request from the second MLD. Otherwise, the first MLD may not share the statistics report with the second MLD. Solicited mode statistics report sharing is shown in FIG. 4 and FIG. 5.

FIG. 4 illustrates an example of solicited mode (aperiodic mode) statistics report sharing 400 according to embodiments of the present disclosure. The embodiment of statistics report sharing of FIG. 4 is for illustration only. Different embodiments of solicited mode (aperiodic mode) statistics report sharing could be used without departing from the scope of this disclosure.

The statistics report sharing example of FIG. 4 begins at step 410. At step 410, a non-AP MLD 402 transmits a request frame (for example, a management frame such as an SCS request frame) that indicates a “solicited” report type to an AP MLD 404. In response, AP MLD 404 transmits a response frame (for example, a management frame such as an SCS response frame) that indicates a “solicited” report type to non-AP MLD 402, resulting in a successful negotiation for statistics information sharing.

At step 412, non-AP MLD 402 and AP MLD 404 exchange a number of frames. After the exchange of frames, at step 414, non-AP MLD 402 transmits a statistics report request to AP MLD 404.

At step 416, in response to the statistics report request, AP MLD 404 transmits a statistics report based on the frame exchanges at step 412 to non-AP MLD 402. For example, the statistics report may include downlink traffic statistics for the frame exchanges from step 412.

At step 418, non-AP MLD 402 and AP MLD 404 exchange another number of frames.

Although FIG. 4 illustrates one example of solicited mode (aperiodic mode) statistics report sharing, various changes may be made to FIG. 4. For example, various changes to the negotiation could be made, etc. according to particular needs.

FIG. 5 illustrates another example of solicited mode (aperiodic mode) statistics report sharing 500 according to embodiments of the present disclosure. The embodiment of statistics report sharing of FIG. 5 is for illustration only. Different embodiments of solicited mode (aperiodic mode) statistics report sharing could be used without departing from the scope of this disclosure.

The statistics report sharing example of FIG. 5 begins at step 510. At step 510, an AP MLD 504 transmits a request frame (for example, a management frame such as an SCS request frame) that indicates a “solicited” report type to a non-AP MLD 502. In response, non-AP MLD 502 transmits a response frame (for example, a management frame such as an SCS response frame) that indicates a “solicited” report type to AP MLD 504, resulting in a successful negotiation for statistics information sharing.

At step 512, non-AP MLD 502 and AP MLD 504 exchange a number of frames. After the exchange of frames, at step 514, AP MLD 504 transmits a statistics report request to non-AP MLD 502.

At step 516, in response to the statistics report request, non-AP MLD 502 transmits a statistics report based on the frame exchanges at step 512 to AP MLD 504. For example, the statistics report may include uplink traffic statistics for the frame exchanges from step 512.

At step 518, non-AP MLD 502 and AP MLD 504 exchange another number of frames.

Although FIG. 5 illustrates one example of solicited mode (aperiodic mode) statistics report sharing, various changes may be made to FIG. 5. For example, various changes to the negotiation could be made, etc. according to particular needs.

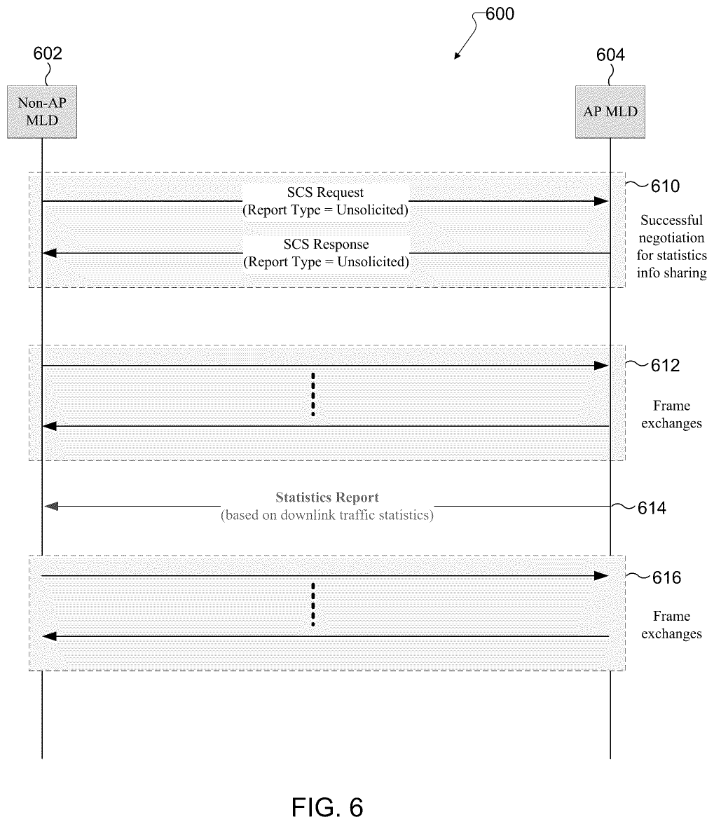

In the unsolicited mode of statistics report sharing, a first MLD can share a latency statistics report with a second MLD without receiving any statistics report request from the second MLD. In this mode of report sharing, the first MLD may share the report without following a fixed report sharing schedule. For example, in some embodiments, an AP MLD may share a latency statistics report with a non-AP MLD in an unsolicited manner when the AP MLD observes degradation of downlink latency for that non-AP MLD for one or more applications. Unsolicited mode statistics report sharing is shown in FIG. 6.

FIG. 6 illustrates an example of an unsolicited mode statistics report sharing 600 according to embodiments of the present disclosure. The embodiment of statistics report sharing of FIG. 6 is for illustration only. Different embodiments of unsolicited mode statistics report sharing could be used without departing from the scope of this disclosure.

The statistics report sharing example of FIG. 6 begins at step 610. At step 610, a non-AP MLD 602 transmits a request frame (for example, a management frame such as an SCS request frame) that indicates an “unsolicited” report type to an AP MLD 604. In response, AP MLD 604 transmits a response frame (for example, a management frame such as an SCS response frame) that indicates an “unsolicited” report type to non-AP MLD 602, resulting in a successful negotiation for statistics information sharing.

At step 612, non-AP MLD 602 and AP MLD 604 exchange a number of frames. During the exchange of frames, AP MLD 604 observes degradation of downlink latency for non-AP MLD 602 for one or more applications.

At step 614, in response to the degradation of downlink latency, AP MLD 604 transmits a statistics report based on the frame exchanges at step 612 to non-AP MLD 602. For example, the statistics report may include downlink traffic statistics for the frame exchanges from step 612.

At step 616, non-AP MLD 602 and AP MLD 604 exchange another number of frames.

Although FIG. 6 illustrates one example of unsolicited mode statistics report sharing, various changes may be made to FIG. 6. For example, various changes to the negotiation could be made, etc. according to particular needs.

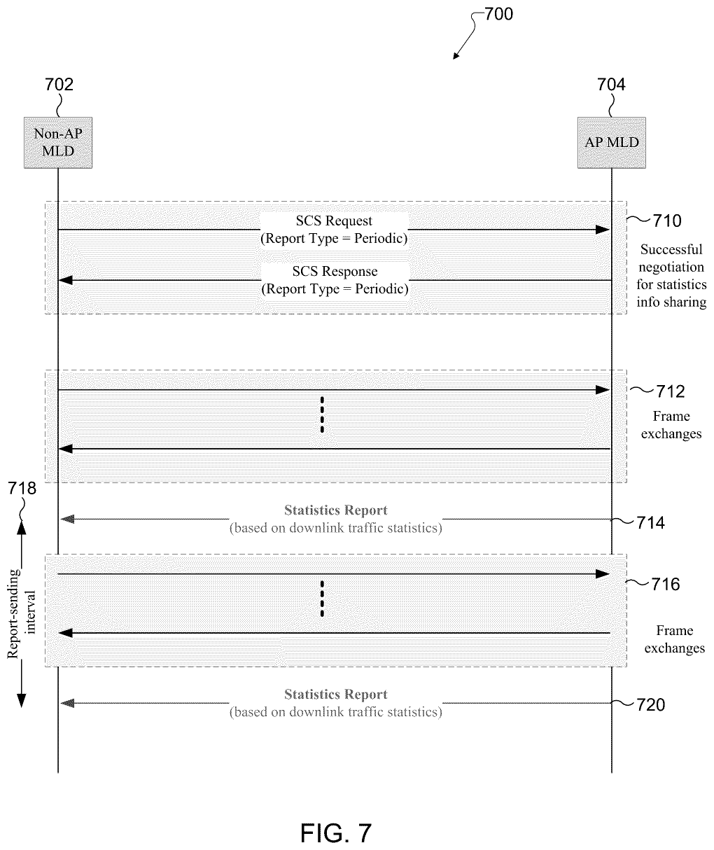

In the periodic mode of statistics report sharing, a first MLD can share a latency statistics report with a second MLD in a periodic manner. For example, the first MLD may periodically send the report to the second MLD at a certain interval. Periodic mode statistics report sharing is illustrated in FIG. 7.

FIG. 7 illustrates an example of periodic mode statistics report sharing 700 according to embodiments of the present disclosure. The embodiment of statistics report sharing of FIG. 7 is for illustration only. Different embodiments of periodic mode statistics report sharing could be used without departing from the scope of this disclosure.

The statistics report sharing example of FIG. 7 begins at step 710. At step 710, a non-AP MLD 702 transmits a request frame (for example, a management frame such as an SCS request frame) that indicates a “periodic” report type to an AP MLD 704. In response, AP MLD 704 transmits a response frame (for example, a management frame such as an SCS response frame) that indicates a “periodic” report type to non-AP MLD 702, resulting in a successful negotiation for statistics information sharing.

At step 712, non-AP MLD 702 and AP MLD 704 exchange a number of frames. After the exchange of frames, at step 714, AP MLD 704 transmits a statistics report based on the frame exchanges at step 712 to non-AP MLD 702. For example, the statistics report may include downlink traffic statistics for the frame exchanges from step 712.

At step 716, non-AP MLD 702 and AP MLD 704 exchange another number of frames for a report sending interval 718. Upon reaching the report sending interval 718, at step 720, AP MLD 704 transmits another statistics report based on the frame exchanges at step 716 to non-AP MLD 702.

Although FIG. 7 illustrates one example of periodic mode statistics report sharing, various changes may be made to FIG. 7. For example, various changes to the negotiation could be made, etc. according to particular needs.

In FIGS. 4, 6, and 7, the AP MLDs 404, 604, and 704 successfully negotiate for the report type requested by the non-AP MLDs 402, 602, and 702. However, it should be understood that in some embodiments, an AP MLD may not accept the request from the non-AP MLD. For example, in some embodiments, the AP MLD may transmit a response to the non-AP MLD rejecting the request. In some embodiments, the AP MLD may transmit a response to the non-AP MLD suggesting an alternative proposal. For example, if the non-AP MLD transmitted a request for solicited mode statistics report sharing, the AP MLD may respond suggesting periodic mode or unsolicited mode statistics report sharing.

In FIG. 5, the non-AP MLD 502 successfully negotiates for the report type requested by the AP MLD 504. However, it should be understood that in some embodiments, a non-AP MLD may not accept the request from the AP MLD. For example, in some embodiments, the non-AP MLD may transmit a response to the AP MLD rejecting the request. In some embodiments, the non-AP MLD may transmit a response to the AP MLD suggesting an alternative proposal. For example, if the AP MLD transmitted a request for solicited mode statistics report sharing, the non-AP MLD may respond suggesting periodic mode or unsolicited mode statistics report sharing.

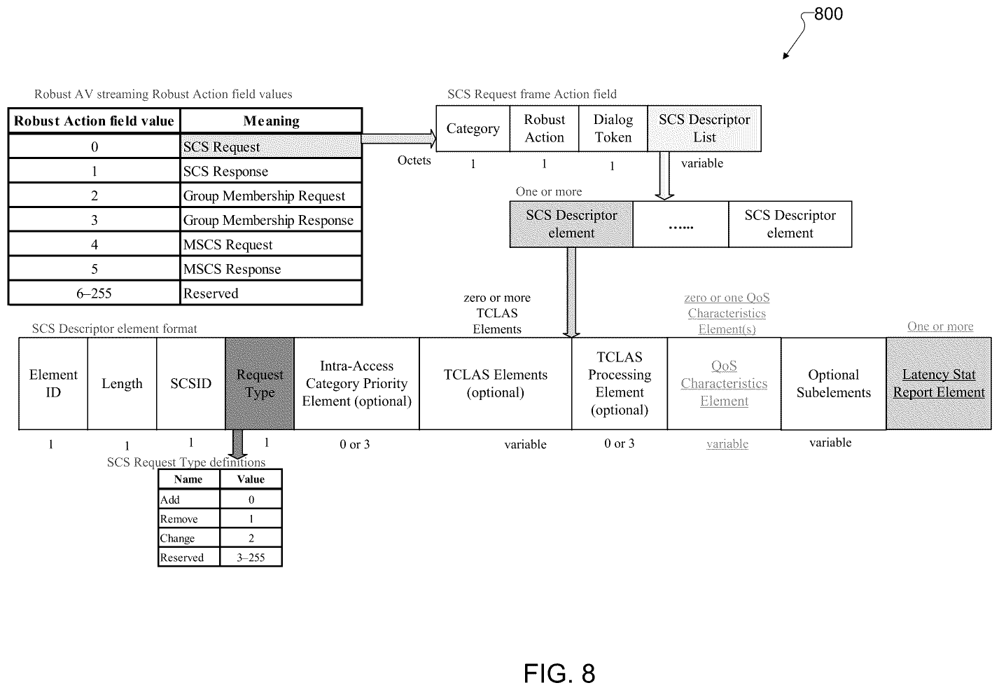

As previously noted, in some embodiments, for the scenario where a first STA intends to request a second STA to share latency information, the first STA can send a SCS request frame to the second STA. In embodiments such as these, the SCS request frame may include one or more latency statistics (stat) report element fields. An example of a possible format of the SCS request frame including the latency stat report element field is shown in FIG. 8.

FIG. 8 illustrates an example SCS request frame format 800 that includes a latency stat report element field according to embodiments of the present disclosure. The embodiment of an SCS request frame format of FIG. 8 is for illustration only. Different embodiments of an SCS request frame format that includes a latency stat report element field could be used without departing from the scope of this disclosure.

In the example of FIG. 8, the SCS request frame includes the following elements:
Category
Robust Action
Dialog Token
SCS Descriptor List

The SCS request frame contains one or more SCS descriptor elements within the SCS descriptor list element. Each SCS descriptor element may have the format shown in FIG. 8, which includes the following fields:
Element ID
Length
SCSID
Request Type
Intra-Access Category Priority Element (optional)
TCLAS Elements (optional)
TCLAS Processing Element (optional)
QoS characteristics element
Optional Subelements
Latency Stat Report Element.

In the example of FIG. 8, the request type field in the SCS descriptor element includes the following fields:
Add
Remove
Change
Reserved

In the example of FIG. 8, the latency stat report element field in the SCS descriptor element may contain one or more latency stat report elements.

Although FIG. 8 illustrates one example SCS request frame format 800 that includes a latency stat report element field, various changes may be made to FIG. 8. For example, various changes to the fields could be made, etc. according to particular needs.

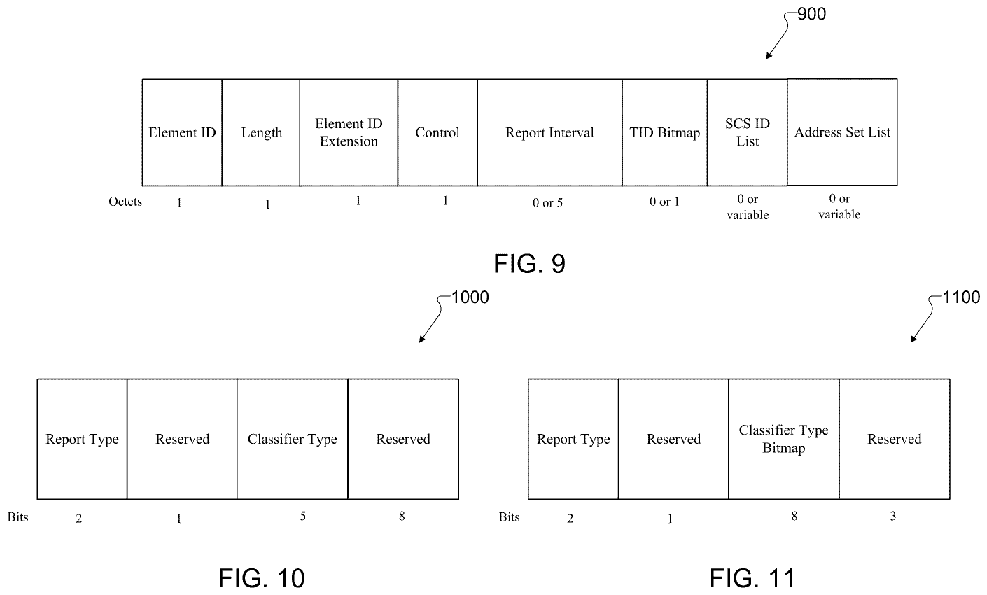

In some embodiments, a latency stat report element field in an SCS descriptor element may have a format similar as shown in FIG. 9.

FIG. 9 illustrates an example latency stat report element format 900 according to embodiments of the present disclosure. The embodiment of a latency stat report element format of FIG. 9 is for illustration only. Different embodiments of a latency stat report element format that could be used without departing from the scope of this disclosure.

In the example of FIG. 9, the latency stat report element includes the following fields:
Element ID
Length
Element ID Extension
Control
Report Interval
Traffic Identifier (TID) Bitmap
SCS ID List
Address Set List

Although FIG. 9 illustrates one example latency stat report element format 900, various changes may be made to FIG. 9. For example, various changes to the fields could be made, etc. according to particular needs.

In some embodiments, a control field of a latency stat report element may have a format similar as shown in FIG. 10.

FIG. 10 illustrates an example control field format 1000 according to embodiments of the present disclosure. The embodiment of a control field format of FIG. 10 is for illustration only. Different embodiments of a control field format could be used without departing from the scope of this disclosure.

In the example of FIG. 10, the control field includes the following fields:
Report Type
a first reserved field
Classifier Type
a second reserved field

In the example of FIG. 10, the report type field may indicate a type of statistics report requested by the sender of the element. A possible encoding of the report type field is shown in Table 1.

TABLE 1
A possible encoding of the Report Type field

| Report Type | |
|---|---|
| field value | Report type |
| 0 | Solicited report |
| 1 | Unsolicited report |
| 2 | Periodic report |
| 3 | reserved |

In the example of FIG. 10, the classifier type field may indicate the basis of traffic statistics. A possible encoding of the classifier type field is shown in Table 2.

TABLE 2
A possible encoding of the Report Type field

| Report Type | |
|---|---|
| field value | Report type |
| 0 | TID Based |
| 1 | SCS Based |
| 2 | Address Based |
| 3 | reserved |

Although FIG. 10 illustrates one example control field format 1000, various changes may be made to FIG. 10. For example, various changes to the fields could be made, etc. according to particular needs.

In some embodiments, a control field of a latency stat report element may have a format similar as shown in FIG. 11.

FIG. 11 illustrates another example control field format 1100 according to embodiments of the present disclosure. The embodiment of a control field format of FIG. 11 is for illustration only. Different embodiments of a control field format could be used without departing from the scope of this disclosure.

In the example of FIG. 11, the control field includes the following fields:
Report Type
a first reserved field
Classifier Type Bitmap
a second reserved field

Although FIG. 11 illustrates one example control field format 1100, various changes may be made to FIG. 11. For example, various changes to the fields could be made, etc. according to particular needs.

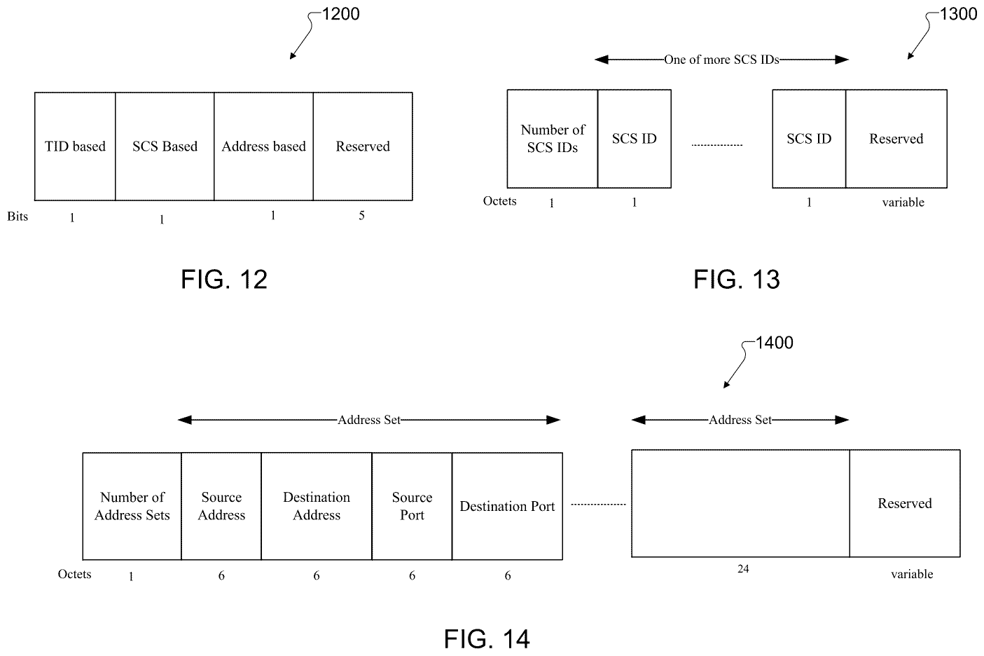

In some embodiments, a classifier type bitmap field (for example, as shown in FIG. 11), may have a format similar as shown in FIG. 12.

FIG. 12 illustrates an example classifier type bitmap field format 1200 according to embodiments of the present disclosure. The embodiment of a classifier type bitmap field format of FIG. 12 is for illustration only. Different embodiments of a classifier type bitmap field format could be used without departing from the scope of this disclosure.

In the example of FIG. 12, the classifier type bitmap field includes the following fields:
TID based
SCS based
Address based
Reserved

Although FIG. 12 illustrates one example classifier type bitmap field format 1200, various changes may be made to FIG. 12. For example, various changes to the fields could be made, etc. according to particular needs.

In some embodiments, if a classier type is indicated in a control field of a latency stat report element, (for example, similar as shown in FIGS. 10-12), then a corresponding field can be present in the latency stat report element (for example, TID bitmap, SCS ID List, and/or Address Set List similar as shown in FIG. 9).

In some embodiments, an SCS ID list of a latency stat report element may have a format similar as shown in FIG. 13.

FIG. 13 illustrates an example SCS ID list format 1300 according to embodiments of the present disclosure. The embodiment of an SCS ID list format of FIG. 13 is for illustration only. Different embodiments of an SCS ID list could be used without departing from the scope of this disclosure.

In the example of FIG. 13, the SCS ID list includes the following fields:
Number of SCS IDs
SCS ID (One field for each SCS ID). For example, if the number of SCSs indicated in the number of SCS IDs field is 3, then 3 SCS ID fields are included in the SCS ID list.
Reserved

Although FIG. 13 illustrates one example SCS ID list format 1300 various changes may be made to FIG. 13. For example, various changes to the fields could be made, etc. according to particular needs.

In some embodiments, an address set list of a latency stat report element may have a format similar as shown in FIG. 14.

FIG. 14 illustrates an example address set list format 1400 according to embodiments of the present disclosure. The embodiment of an address set list format of FIG. 14 is for illustration only. Different embodiments of an address set list could be used without departing from the scope of this disclosure.

In the example of FIG. 14, the address set list includes the following fields:
Number of Address Sets
Source Address (one field for each address set)
Destination Address (one field for each address set)
Source Port (one field for each address set)
Destination Port (one field for each address set)

As noted above, in the example of FIG. 14, the address set list includes a source address field, destination address field, source port field, and destination port field for each address set. For example, if the number of address sets indicated in the number of address sets field is 3, then 3 SCS ID source address fields, destination address fields, source port fields, and destination port fields are included in the address set list. In the example of FIG. 14, for each address set, the corresponding source address field, destination address field, source port field, and destination port field are grouped to together in the address set list.

Although FIG. 14 illustrates one example address set list format 1400 various changes may be made to FIG. 14. For example, various changes to the fields could be made, etc. according to particular needs.

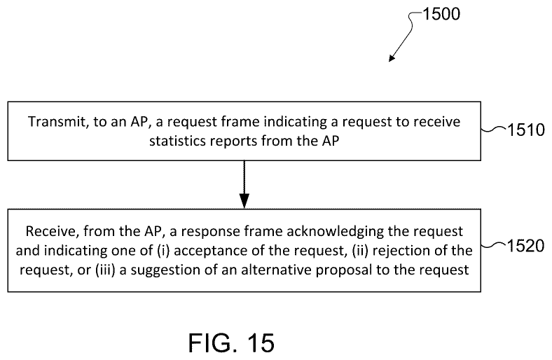

FIG. 15 illustrates an example method for MLD information sharing 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments for MLD information sharing could be used without departing from the scope of this disclosure.

In the example of FIG. 15, method 1500 is performed by a STA (such as non-AP MLD 402, 602, or 702) configured to perform negotiation for statistics information sharing with an AP (such as AP MLD 404, 604, or 704). In some embodiments, the STA may be a first MLD and the AP may be a second MLD. Method 1500 begins at step 1510.

At step 1510, as part of a negotiation for statistics information sharing, the STA transmits, to the AP, a request frame indicating a request to receive statistics reports from the AP. In some embodiments, the request frame may be a management frame such as an SCS request frame.

At step 1520, as part of the negotiation for statistics information sharing, the STA receives, from the AP, a response frame acknowledging the request and indicating one of (i) acceptance of the request, (ii) rejection of the request, or (iii) a suggestion of an alternative proposal to the request. In some embodiments, the response frame may be a management frame such as an SCS response frame.

In some embodiments, where the request frame is an SCS request frame, the request may be indicated in a latency stat report element of the SCS request frame. For example, the SCS request frame may have a format similar as shown in FIG. 8. In embodiments such as these, the latency stat report element may indicate that traffic statistics for the statistics reports are one of TID based, SCS based, or address based. The latency stat report element may also indicate a report type requested by the STA is one of a solicited report, an unsolicited report, or a periodic report. For example, the latency stat report element may have a format similar as shown in FIG. 9.

In some embodiments, where the report type requested by the STA is a solicited report, the STA may transmit, to the AP, a request to receive a statistics report, and receive, from the AP, a statistics report corresponding to the request, similar as shown in FIGS. 4 and 5.

In some embodiments, where the report type requested by the STA is a periodic report, the STA may periodically, after a report-sending internal, receive a statistics report from the AP corresponding to the report-sending interval, similar as shown in FIG. 7.

In some embodiments, prior to the negotiation, the STA may receive a message from the AP including an indication that the AP supports statistics report sharing. In embodiments such as these, the STA may perform the negotiation in response to the indication that the AP supports statistics report sharing. In some embodiments, the message including the indication may be one of a beacon frame, a probe response frame, an association response frame, and a reassociation response frame. In embodiments such as these, the indication may be included in at least one of an HT capabilities element, a VHT capabilities element, and HE capabilities element, and EHT capabilities element, a UHR capabilities element, and a WFA-specific element.

Although FIG. 15 illustrates one example method for MLD information sharing 1500, various changes may be made to FIG. 15. For example, while shown as a series of steps, various steps in FIG. 15 could overlap, occur in parallel, occur in a different order, occur any number of times, be omitted, or replaced by other steps.

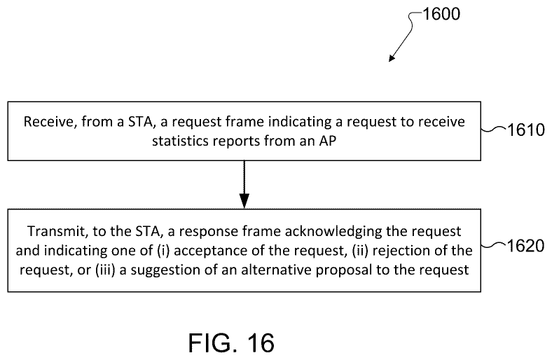

FIG. 16 illustrates an example method for MLD information sharing 1600 according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments for MLD information sharing could be used without departing from the scope of this disclosure.

In the example of FIG. 16, method 1600 is performed by an AP (such as AP MLD 404, 604, or 704) configured to perform negotiation for statistics information sharing with a STA (such as non-AP MLD 402, 602, or 702). In some embodiments, the STA may be a first MLD and the AP may be a second MLD. Method 1600 begins at step 1610.

At step 1610, as part of a negotiation for statistics information sharing, the AP receives, from the STA, a request frame indicating a request to receive statistics reports from the AP. In some embodiments, the request frame may be a management frame such as an SCS request frame.

At step 1620, as part of the negotiation for statistics information sharing, the AP transmits, to the STA, a response frame acknowledging the request and indicating one of (i) acceptance of the request, (ii) rejection of the request, or (iii) a suggestion of an alternative proposal to the request. In some embodiments, the response frame may be a management frame such as an SCS response frame.

In some embodiments, where the request frame is an SCS request frame, the request may be indicated in a latency stat report element of the SCS request frame. For example, the SCS request frame may have a format similar as shown in FIG. 8. In embodiments such as these, the latency stat report element may indicate that traffic statistics for the statistics reports are one of TID based, SCS based, or address based. The latency stat report element may also indicate a report type requested by the STA is one of a solicited report, an unsolicited report, or a periodic report. For example, the latency stat report element may have a format similar as shown in FIG. 9.

In some embodiments, where the report type requested by the STA is a solicited report, the AP may receive, from the STA, a request to receive a statistics report, and transmit, to the STA, a statistics report corresponding to the request, similar as shown in FIGS. 4 and 5.

In some embodiments, where the report type requested by the STA is a periodic report, the AP may periodically, after a report-sending internal, transmit a statistics report to the STA corresponding to the report-sending interval, similar as shown in FIG. 7.

In some embodiments, prior to the negotiation, the AP may transmit a message from the AP including an indication that the AP supports statistics report sharing. In some embodiments, the message including the indication may be one of a beacon frame, a probe response frame, an association response frame, and a reassociation response frame. In embodiments such as these, the indication may be included in at least one of an HT capabilities element, a VHT capabilities element, and HE capabilities element, and EHT capabilities element, a UHR capabilities element, and a WFA-specific element.

Although FIG. 16 illustrates one example method for MLD information sharing 1600, various changes may be made to FIG. 16. For example, while shown as a series of steps, various steps in FIG. 16 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A station (STA) comprising:
a processor configured to perform a negotiation for statistics information sharing with an access point (AP); and
a transceiver operatively coupled to the processor, the transceiver configured to, as part of the negotiation:
transmit, to the AP, a request frame indicating a request to receive statistics reports from the AP; and
receive, from the AP, a response frame acknowledging the request and indicating one of (i) acceptance of the request, (ii) rejection of the request, or (iii) a suggestion of an alternative proposal to the request.

2. The STA of claim 1, wherein:
the request frame is a stream classification service (SCS) request frame;
the response frame is an SCS response frame; and
the request is indicated in a latency statistics (stat) report element of the SCS request frame.

3. The STA of claim 2, wherein the latency stat report element indicates that traffic statistics for the statistics reports are one of traffic identifier (TID) based, SCS based, or address based.

4. The STA of claim 2, wherein the latency stat report element indicates a report type requested by the STA is one of a solicited report, an unsolicited report, or a periodic report.

5. The STA of claim 4, wherein:
the report type requested by the STA is a solicited report; and
the transceiver is further configured to:
transmit, to the AP, a request to receive a statistics report; and
receive, from the AP, a statistics report corresponding to the request.

6. The STA of claim 4, wherein:
the report type requested by the STA is a periodic report; and
the transceiver is further configured to periodically, after a report-sending interval, receive a statistics report from the AP corresponding to the report-sending interval.

7. The STA of claim 1, wherein:
the transceiver is further configured to, prior to the negotiation, receive a message from the AP including an indication that the AP supports statistics report sharing; and
the processor is further configured to perform the negotiation in response to the indication.

8. The STA of claim 7, wherein the message is one of:
a beacon frame;
a probe response frame;
an association response frame; and
a reassociation response frame.

9. The STA of claim 8, wherein the indication is included in at least one of:
a high throughput (HT) capabilities element;
a very high throughput (VHT) capabilities element;
a high efficiency (HE) capabilities element;
an extremely high throughput (EHT) capabilities element;
an ultra high reliability (UHR) capabilities element; and
a Wi-Fi Alliance (WFA)-specific element.

10. STA of claim 1, wherein:
the STA is a first multi-link device (MLD); and
the AP is a second MLD.

11. An access point (AP) comprising:
a processor configured to perform a negotiation for statistics information sharing with a station (STA); and
a transceiver operatively coupled to the processor, the transceiver configured to, as part of the negotiation:
receive, from the STA, a request frame indicating a request to receive statistics reports from the AP; and
transmit, to the STA, a response frame acknowledging the request and indicating one of (i) acceptance of the request, (ii) rejection of the request, or (iii) a suggestion of an alternative proposal to the request.

12. The AP of claim 11, wherein:
the request frame is a stream classification service (SCS) request frame;
the response frame is an SCS response frame; and
the request is indicated in a latency statistics (stat) report element of the SCS request frame.

13. The AP of claim 12, wherein the latency stat report element indicates that traffic statistics for the statistics reports are one of traffic identifier (TID) based, SCS based, or address based.

14. The AP of claim 12, wherein the latency stat report element indicates a report type requested by the STA is one of a solicited report, an unsolicited report, or a periodic report.

15. The AP of claim 14, wherein:
the report type requested by the STA is a solicited report; and
the transceiver is further configured to:
receive, from the STA, a request to receive a statistics report; and
transmit, to the STA, a statistics report corresponding to the request.

16. The AP of claim 14, wherein:
the report type requested by the STA is a periodic report; and
the transceiver is further configured to periodically, after a report-sending interval, transmit a statistics report to the STA corresponding to the report-sending interval.

17. The AP of claim 11, wherein:
the transceiver is further configured to, prior to the negotiation, transmit a message to the STA including an indication that the AP supports statistics report sharing.

18. The AP of claim 17, wherein the message is one of:
a beacon frame;
a probe response frame;
an association response frame; and
a reassociation response frame.

19. The AP of claim 18, wherein the indication is included in at least one of:
a high throughput (HT) capabilities element;
a very high throughput (VHT) capabilities element;
a high efficiency (HE) capabilities element;
an extremely high throughput (EHT) capabilities element;
an ultra high reliability (UHR) capabilities element; and
a Wi-Fi Alliance (WFA)-specific element.

20. The AP of claim 11, wherein:
the STA is a first multi-link device (MLD); and
the AP is a second MLD.
